(19) United States
(12) Patent Application Publication
(10) Pub. No.: US 2016/0209309 A1
(43) Pub. Date: Jul. 21, 2016

(54) SEDIMENT SOUNDING POLE AND HANDHELD DENSITY PROFILER

(71) Applicant: DOTOCEAN NV, Brugge (BE)

(72) Inventors: Peter STAELENS, Brugge (BE); Koen GEIRNAERT, Drongen (BE); Sebastien DEPREZ, Houthulst (BE)

(21) Appl. No.: 15/060,049

(22) Filed: Mar. 3, 2016

Related U.S. Application Data
(63) Continuation-in-part of application No. PCT/EP2014/068774, filed on Sep. 3, 2014.

(30) Foreign Application Priority Data
Sep. 3, 2013 (GB) 1315687.2

(51) Int. Cl. G01N 9/00; G01N 3/42

(52) U.S. Cl. CPC G01N 9/00; G01N 3/42

(57) ABSTRACT

A handheld profiling system for obtaining information regarding a mud, sediment, sand or soil is disclosed. The handheld profiling system comprises a sounding pole, a sensor array provided along the sounding pole, the sensor array being configured for providing a different output signal in air, water and sediment, and a measurement unit for determining a resistance on the sounding pole when intruding the sediment. A corresponding processing means and computer program product is also described.

### FIELD OF THE INVENTION

The invention relates to the field of soil structure, sediment, suspended sediment, sand or dredged material evaluation. More particularly, the present invention relates to methods and systems for analyzing the sediment build-up, structure and/or composition, e.g. for determining the thickness, density, strength and position of underwater sediment layers.

### BACKGROUND OF THE INVENTION

In preparation of dredging works the physical parameters of the underwater soil structures and sediment layers need to be characterized. Sediment layers can be from a few centimeters till several meters thick, can be loose or consolidated. Important parameters to be measured are the thickness of the sediment layer, the density, the strength and the position of the sediment layer under water.

Before a dredging campaign the dredged volume and the ton dry weight of the dredged volume need to be determined. One of the methods in smaller waterways is to measure via a handheld sounding pole the top level of the sediment layer and the depth of the hard or soil layer. A classic handheld sounding pole is manually pushed into the sediment by an operator. On top of the rod there is a disc surface. The surface is causing a resistance when entered into the sediment. To detect the top of the sediment layer a big surface disc is used since the strength on the top of the sediment is weaker. To detect the hard bottom or soil layer a smaller disc is used. Due to the manual operation and difference in used force on the rod, the measured resistance and hence detected depth of the sediment layer is variable and sensitive for interpretation. More particularly, results typically depend on the person handling the sounding pole and the force used by this person.

Next to the volume of sediment to be dredged also the density of the volume is important. Once the sediment layers are dredged and collected in the hopper also a density profile of the hopper mud over the depth of the hopper needs to be measured.

During dredging or before dredging the density of suspended sediment layers flowing over the bottom can be monitored in order to evaluate the total transported sediment mass. The strength of the loose sediment can either be derived from mechanical interaction with the sediment or from the density distribution in the sediment.

### SUMMARY OF THE INVENTION

It is an object of embodiments of the present invention to provide an intelligent sounding pole allowing to determine information of a sediment, sand, soil or mud substantially independent of operating characteristics.

It is an advantage of embodiments of the present invention that a sounding pole is provided with sensors for identifying the medium on board. The on board sensors for identifying the medium typically may be able to detect the top water level and the top sediment level and the hard soil level in an automatic way. By measuring e.g. the velocity and force of intrusion the measured resistance of the sediment can be scaled and made independent of the used force. The latter is important to determine an independent criterion for a hard bottom or soil level.

The above object will be accomplished by a system and method according to the present invention.

In one aspect, the present invention relates to a handheld profiling system for obtaining information regarding a mud, sediment, sand or soil, the handheld profiling system comprising

a sounding pole

a magnetic sensor unit comprising a floating member slideably mounted on the sounding pole, a magnetic element comprised in the floating member and a magnetic sensor array provided along the sounding pole, the sensor array being configured for identifying a position of the magnetic element along the sounding pole,

a measurement unit for determining at least one of a point resistance, a water pressure or a shear resistance on the sounding pole, and

a processing unit programmed for determining, based on an output of the magnetic sensor unit and on an output of the measurement unit information of the mud, sediment, sand or soil substantially independent of operator characteristics of the way of introducing the handheld profiling sounding pole.

The magnetic sensor array may be integrated in the sounding pole.

The magnetic sensor array may be an array of hall sensor elements.

The processing unit may be programmed for determining the applied force of the operator on the sounding pole using a force balance based on the overall force and a resistance measurement or wherein the processing unit is programmed for determining the applied energy of the operator on the sounding pole using an energy balance based on the kinetic energy and energy losses on the sounding pole.

The processing unit may be programmed for determining based on the magnetic sensor unit and the measurement unit information on the interface of air and water.

The processing unit may be programmed for determining based on the magnetic sensor unit and the measurement unit information on the interface of water and sediment

The processing means may be programmed for determining a speed of the rod based on a sensor output of sensors in the magnetic sensor array during said profiling.

The processing unit may be programmed for determining a hard bottom of a waterway based on an output of the measurement unit.

The measurement unit may be a cone resistance measurement unit.

The measurement unit may be configured for determining a shear strength or a cone penetration resistance and/or wherein the sounding pole has a conically shaped top.

The measurement unit may comprise an electric strain gauge for determining any of a point resistance, a water pressure or a shear resistance.

The system furthermore may comprise a membrane for shielding the strain gauge from water.

The system furthermore may comprise a chemical sensor for measuring contamination.

The system may comprise an accelerometer whereby the processing unit is further programmed for determining an overall force on the rod based on accelerometer data.

The system may comprise an inclinometer configured for providing information regarding an overall inclination of the sounding pole.

The system may comprise a GPS configured for providing information regarding an overall position of the sounding pole.

The system may comprise a conductivity sensor and an inductor oriented along the length of the profiling system configured for determining a fluid level based on an inductance measured in the inductor.

The magnet may be any of a permanent magnet or an electromagnet.

The system also may not comprise the processing unit but may be adapted instead for communicating data to the processing unit, whereby the processing unit then may be a separate unit, e.g. positioned away from the system.

The present invention also relates to a processing unit for use with a handheld profiling system, the processing unit being programmed for determining, based on an output of a magnetic sensor unit comprising a floating member slideably mounted on a sounding pole, a magnetic element comprised in the floating member and a magnetic sensor array provided along the sounding pole, the magnetic sensor array being configured for identifying a position of the magnetic element along the sounding pole and a measurement unit for determining at least one of a point resistance, a water pressure or a shear resistance on the sounding pole, information of the mud, sediment, sand or soil substantially independent of operator characteristics of the way of introducing the handheld profiling sounding pole.

The processing unit may be programmed for determining based on the magnetic sensor unit and the measurement unit information the interface of air and water.

The processing unit may be programmed for determining a speed of the sounding pole based on the magnetic sensor unit during said profiling.

The processing unit may be programmed for determining a hard bottom of a waterway based on an output of the measurement unit.

The processing unit may be programmed for determining the applied force of the operator on the sounding pole using a force balance based on the overall force and a resistance measurement.

The processing unit may be programmed for determining the applied energy of the operator on the sounding pole using an energy balance based on the kinetic energy and energy losses on the sounding pole.

The present invention also relates to a method for determining information regarding a mud, sediment, sand or soil, the method comprising, introducing a handheld profiling sounding pole into a waterway until a hard layer is reached,

obtaining, during said introducing, information of a magnetic sensor unit comprising a floating member slideably mounted on the sounding pole, a magnetic element comprised in the floating member and a magnetic sensor array provided along the sounding pole, the sensor array being configured for identifying a position of the magnetic element along the sounding pole, and information of a measurement unit for determining at least one of a point resistance, a water pressure or a shear resistance on the sounding pole, and

determining based on the obtained information, information of the mud, sediment, sand or soil substantially independent of operator characteristics of the way of introducing the handheld profiling sounding pole.

The present invention also relates to a computer program product for determining information of a mud, sediment, sand and/or soil, the computer program product being adapted for, when run on a computer, the functionality of the processing means as described above. The computer program product may be a web application.

The present invention also relates to a data carrier comprising a computer program product as described above. The invention also relates to the transmission of the computer program product as described above over a local or wide area network.

It is also an object of the present invention to provide a good system for obtaining information regarding a mud, sediment, sand or soil.

In one aspect, the present invention relates to a profiling system for obtaining information regarding a mud, sediment, sand or soil, the profiling system comprising a gauging rod, a sensor array provided along the gauging rod, the sensor array being configured for providing a different output signal in air, water and sediment. In some embodiments, wherein the profiling system is a handheld profiling system, the system also may comprise a measurement unit for determining a resistance on the gauging rod when intruding the sediment. The profiling system may be in some embodiments a system that can be positioned, e.g. in a fixed manner, in a place of interest. The sensor array than may be adapted for providing information regarding a mud, sediment, sand or soil. Alternatively, the gauging rod may be a sounding pole and the profiling system may be a handheld device. In such cases, the system typically also comprises the measurement unit for determining a resistance as mentioned above.

The sensor array may be integrated in the sounding pole.

The system furthermore may comprise a processing unit for determining, based on an output of the sensor array and optionally also on an output of the measurement unit for determining a resistance, information of the mud, sediment, sand or soil. In case of a handheld device, the latter may be determined independent of a force or power applied by the user on the sounding pole.

The processing unit may be adapted for determining based on the sensor array information the interface of air and water.

The processing unit may be adapted for determining based on the sensor array information the interface of water and sediment.

The processing means may be adapted for determining, in case of a handheld device, a speed of the rod based on a sensor output variation of sensors in the sensor array positioned around the interface during said profiling.

In some embodiments, the processing unit may be adapted for determining a hard bottom of a waterway based on an output of the measurement unit.

The processing unit may be, e.g. when the system is a handheld device, adapted for determining the applied force of the operator on the sounding pole using a force balance based on the overall force and a resistance measurement.

The processing unit may be adapted for determining, in case of a handheld device, the applied energy of the operator on the sounding pole using an energy balance based on the kinetic energy and energy losses on the sounding pole.

The measurement unit may be a cone resistance measurement unit. The measurement unit may be any of a point resistance measurement unit, a water pressure measurement unit or a shear resistance measurement unit.

The measurement unit may be adapted for determining a shear strength or a cone penetration resistance.

The measurement unit may be adapted for determining a cone penetration resistance by measuring a piezoelectric effect on a piezoceramic element and/or by measuring strain using a strain gauge.

The sounding pole may have a conically shaped top.

The system may comprise an accelerometer.

The processing unit may be adapted for determining an overall force on the rod based on accelerometer data.

The system may comprise an inclinometer for providing information regarding an overall inclination of the rod.

The system may comprise a GPS for providing information regarding an overall position on the rod.

The present invention also relates to a processing unit for use with a profiling system, such as for example a handheld profiling system or a stationary profiling system or a profiling system positioned at a location of interest, the processing unit being adapted for determining, based on an output of a sensor array on a sounding pole of the profiling system. In some systems, e.g. especially useful in case of a handheld profiling system, the processing unit may also be programmed for taking into account an output of a measurement unit on the sounding pole of the profiling system, information of the mud, sediment, sand or soil.

The processing unit may be adapted for determining based on the sensor array information the interface of air and water.

The processing unit may be adapted for determining based on the sensor array information the interface of water and sediment.

The processing unit may be adapted for determining a speed of the rod based on a sensor output variation of sensors in the sensor array positioned around the interface during said profiling.

The processing unit may be adapted for determining a hard bottom of a waterway based on an output of the measurement unit.

The processing unit may be adapted for determining the applied force of the operator on the sounding pole using a force balance based on the overall force and a resistance measurement.

The processing unit may be adapted for determining the applied energy of the operator on the sounding pole using an energy balance based on the kinetic energy and energy losses on the sounding pole.

The present invention also relates to a computer program product for determining information of a mud, sediment, sand and/or soil, the computer program product being adapted for, when run on a computer, the functionality of the processing means as described above. The computer program product may be a web application.

The present invention also relates to a data carrier comprising a computer program product as described above. The invention also relates to the transmission of the computer program product as described above over a local or wide area network.

The present invention also relates to a method for determining information regarding a mud, sediment, sand or soil, the method comprising, introducing a handheld profiling sounding pole into a waterway until a hard layer is reached, obtaining, during said introducing, information of a sensor array configured for providing a different output signal in air, water and sediment, and information of a measurement unit for determining a resistance on the sounding pole, and determining based on the obtained information, information of the mud, sediment, sand or soil substantially independent of operator characteristics of the way of introducing the handheld profiling sounding pole.

For determining the top water level and the top sediment level an array of sensors is provided, e.g. integrated, along the rod. When the sensor is in air, water or sediment the output of the sensor will be different. The number of sensors along the rod determines the measurement resolution. A standard rod is typically about 3 m long, for a resolution of 1 cm 1 to 300 sensors can be provided, e.g. integrated, along the rod depending on the post processing strategy. Nevertheless, the length and the resolution used may be different in some embodiments. When the rod is intruded by hand in the sediment, part of the rod will be in air, part in water and part in sediment. The level and height of each section can be determined because the sensors in each different environment provide a different output signal. Potential applicable sensors but not restricted to these are
optical sensors where a led intensity is measured by an photo diode. In air, water and sediment the light intensity will be different allowing to distinguish each layer.
Capacitors where the medium between two capacitor plates is determining the capacity. By varying medium the applied signal will have a different damping.
Any kind of conductivity sensor including georadar measuring variations in electric conductivity or electric resistance in the air/water/soil

By sampling all sensors on the rod in parallel during the intrusion also the intrusion speed of the rod can be determined. The resistance of the sediment is a function of the intrusion speed and sediment characteristics.

By optionally having also accelerometers and/or velocity meters integrated in the sounding pole also the acceleration and the speed of the rod during intrusion and operation can optionally be determined.

On the tip of the rod an instrumented conus and/or sleeve can be installed. On the conus the cone penetration resistance can be determined and on the sleeve the shear resistance can be determined. The way to determine the cone penetration resistance can be by measuring the piezoelectric effect on a piezoceramic element attached to the cone or by measuring strain by a strain gauge but not limited to these two sensors.

In some embodiments, the total force can be measured via the on board accelerometers. The speed can be measured by measuring the variation of the vertical sensors on the interface air water. The inclination of the rod can be measured by inclinometers on board.

If then the sediment resistance force is measured on the conus and the sleeve and the total force is known, the force applied by the operator can be determined.

Alternatively, if the total kinetic energy is known by measuring the speed and the energy losses are measured on the conus and sleeve, the energy injected by the operator can be determined. In one aspect, the present invention also relates to a handheld profiling system for obtaining information regarding a mud, sediment, sand or soil, the handheld profiling system comprising a sounding pole and a sensor array provided along the sounding pole, the sensor array being configured for providing a different output signal in air, water and sediment.

In another aspect, the present invention also relates to a handheld profiling system for obtaining information regarding a mud, sediment, sand or soil, the handheld profiling system comprising a sounding pole and a measurement unit for determining a resistance on the sounding pole when intruding the sediment.

It is also an object of embodiments of the present invention to provide a profiling system based on x-ray analysis for profiling mud, sediment, sand or soil, e.g. after dredging, that is easy to use.

It is an advantage of embodiments of the present invention that a handheld profiling system based on X-ray measurements is provided.

The present invention relates to a profiling system for obtaining information regarding a mud, sediment, sand or soil, the profiling system being a handheld profiling system comprising an X-ray source and a semiconductor based photodetector, the x-ray source and the semiconductor based photodetector being configured for performing X-ray measurements of the mud, sediment, sand or soil for determining a density based on said profiling.

The semiconductor based photodetector may be a silicon based photodetector.

The mass of the profiling system may be less than 10 kg.

The profiling system furthermore may comprise a processing unit for determining, based on said X-ray measurements, a density of the mud, sediment, sand or soil.

The processing means may be configured for determining a depth, thickness, cone resistance or shear strength of underwater sediment layers.

To determine ton dry mass of the measured volume with the sounding pole, the rod can be combined with a small handheld density profiler. The handheld density measurement can be based on X-ray technology. The system can be separated or integrated in the rod. To miniaturize an accurate density profiler that can be used in situ an X-ray source and X-ray detector needs to fit in a small housing. For the detector a silicon based photomultiplier could be used in order to fit in the small housing.

Embodiments of the present invention may allow performing measurements of the sediment density of the sediment layers in small water ways.

It is an advantage of embodiments according to the present invention that systems and methods are provided for determining physical parameters like density and composition images of underwater soil structures. It is an advantage of embodiments according to the present invention that soil structure, soil type and composition can be derived from such parameters.

It is an advantage of embodiments according to the present invention that the systems can be adapted in electronics design and specific in sensor integration to analyze the sediment or sand layer.

It is an object of embodiments of the present invention to provide a good vertical mud or sediment profiler or scanner. It is an advantage of embodiments according to the present invention that a profiler system can be provided that is easier, e.g. through its light weight, to install compared to scanners based on radioactive detectors.

It is an advantage of embodiments according to the present invention that a profiler system can be provided that is more user friendly in installation, transport and use.

It is an advantage of embodiments according to the present invention that a profiler system can be provided that is based on a detection principle that is less harmful and/or less legislated than radioactive detection techniques.

It is an advantage of embodiments according to the present invention that a profiler system or scanner, e.g. a vertical profiler or scanner, for e.g. mud or sedimentation is provided that is based on stationary or moving X-ray transmission hardware in a tube in combination with a stack of X-ray detectors or receivers of any kind, such as a scintillation crystal and photo multiplier tube or any kind of semiconductor based photon detector. The complete profiler may comprise two tubes which are transparent for X-ray. The profiler may consist out of X-ray blocking tubes, such as metal, with X-ray transparent windows at discrete distances in which the X-ray source and receiver are stationary positioned or move up and down. In the first tube the source can operate in the second tube the X-ray detector or receiver can operate. By moving both, sender and receiver synchronous the sediment in between can be characterized.

Embodiments of the present invention may allow performing static measurements of the density, e.g. determining density of a substantially static mud, soil, sediment, etc.

According to some embodiments of the present invention, the system may allow dynamic characterization of a mud, soil, sediment, etc. e.g. determine a mass transport.

It is an advantage of embodiments according to the present invention that systems and methods are provided for determining physical parameters like density and composition images of underwater soil structures. It is an advantage of embodiments according to the present invention that soil structure, soil type and composition can be derived from such parameters.

It is an advantage of embodiments of the present invention that methods and systems are provided adapted for analyzing the combination of physical parameters in parallel to determine e.g. pollution. It is an advantage of embodiments according to the present invention that the systems are adapted in mechanical design so as to allow characterization of the mud or sand layers without disturbing the measured layer. It is an advantage of embodiments according to the present invention that the systems can be adapted in electronics design and specific in sensor integration to analyze the sediment or sand layer.

It is an advantage of embodiments according to the present invention that a physical picture of the mud can be taken and related image processing can be done. It is an advantage that shear-strength, rigidity and viscosity also can be determined via association methods. By measuring the density spectrum of the sediment, maturity and strength of the sediment can be derived. Measuring the density spectrum can be done using an array of photo multipliers and a single X-ray source. The spread on the measured density from each photo multiplier enables the generation of the density spectrum.

It is an advantage of embodiments according to the present invention that component analysis of the scanned mud can be done based on spectrometry.

The above object is obtained by a system and/or method according to the present invention.

The present invention relates to a profiling system for obtaining information regarding a mud, sediment, sand or soil, the system comprising

a first elongated element comprising an x-ray radiation source system for emitting x-rays,

a second elongated element comprising an x-ray detector system for detecting x-rays, the first elongated element and the second elongated element being transparent for x-rays along at least a part of their length and

the x-ray radiation source system and the x-ray detector system being configured in the first elongated element respectively second elongated element so that at a plurality of positions or continuously along the length of the first and the second elongated elements x-ray radiation emitted from the x-ray radiation source system can be detected by the x-ray detector system.

The profiling system may be a closed system, whereby no moving component is in contact with the mud, sediment, sand or soil.

The first elongated element may be a closed element. The second elongated element may be a closed element.

It is an advantage of embodiments of the present invention that the mud or sediment is not disturbed by movement of the source system or detector element.

At least one of the x-ray radiation source system and/or the x-ray radiation detector system may be arranged on a guiding element for moving the x-ray radiation source system and/or the x-ray radiation detector system along a length of the first elongated element respectively the second elongate element.

The x-ray radiation source system may comprise a plurality of radiation sources along the length of the first elongated element and the x-ray detector system may comprise a plurality of x-ray radiation detector elements along the length of the second elongated element, the radiation sources and detector elements being aligned with respect to each other for emitting and receiving x-ray radiation.

The system furthermore may comprise a controller for controlling a movement of the x-ray radiation source system and/or the x-ray detector source system along the guiding element.

The controller may be adapted for synchronously moving the x-ray radiation source system and/or the x-ray detector source system.

The first and/or the second elongate element may comprise position recognition means for recognizing a position of the source system or detector system along the length of the first respectively the second elongate element. Such position recognition means may be optical features.

The first elongate element and the second elongated element may be elements of a single, concave system shaped so as to create a hollow space, the first elongate element and the second elongate element being positioned at opposite sides of said hollow space.

The x-ray source system and the x-ray detector system may be mechanically linked—e.g. connected—to each other and are simultaneously moveable.

The first elongated element and the second elongated element may be two closed separate independent elements. The elements may only be linked through their housing, e.g. to keep them at a fixed distance with respect to each other.

The x-ray radiation source system and the x-ray detector system may be independently moveable.

The system furthermore may comprise a processing means being programmed for deriving, based on said data X-ray receiver data at least one of a density, composition or structure picture of a soil.

The processing means may be programmed for deriving at least the density based on said data.

The system may be adapted for performing an X-ray scan and the processing means may be programmed for determining density, viscosity, yield strength or a material components out of the scan by assigning components to sudden intensity.

The processing means furthermore may be adapted for deriving soil type or soil structure based on said density, shear strength and scan profile.

The present invention also relates to a processing means for determining mud, sediment, sand or soil characteristics, the processing means being adapted for receiving X-ray data recorded of a mud, sediment, sand or soil, and the processing means being programmed for deriving, based on the X-ray data, at least the density of the mud, sediment, sand or soil.

The processing means may be adapted for receiving X-ray data of a profiling system as described above.

The processing means furthermore may be programmed for determining density, viscosity, yield strength or a material components and/or chemical composition out of the scan by assigning components to sudden intensity for a sudden spectrum.

The processing means furthermore may be adapted for deriving soil type or soil structure based on said density, a shear strength and scan profile.

The present invention also relates to a computer program product for determining mud, sediment, sand or soil characteristics, the computer program product providing, when run on a computer, the functionality of the processing means as described above.

The computer program product may be a web application.

The present invention also relates to a data carrier comprising a computer program product as described above or to the transmission of a computer program product as described above over a network, e.g. a local or wide area network.

The present invention also relates to a dredging hopper comprising a profiling system as described above.

The present invention furthermore relates to the use of a profiling system as described above for determining a dynamic characteristic of a mud, sediment, sand or soil. The dynamic characteristic may be a mass transport thereof or therein.

The present invention also relates to the use of a profiling system as described above for determining a static characteristic of a mud, sediment, sand or soil. The static characteristic may be a density thereof.

The present invention also relates to a probing or profiling system for probing or profiling a mud, sediment, sand or soil, the probing or profiling system comprising two or more magnets distanced from each other and a magnetic field sensor for sensing a change in a relative distance between the two or more magnets induced by a resistance or force on the probing system. The magnets may be permanent magnets although embodiments are not limited thereto. The system may comprise a processor for deriving from the magnetic field or magnetic field change measured, a force or resistance on the profiling system. The magnets may be spaced from each other along a probing direction.

In one aspect, the present invention also relates to a fluid level sensing system for determining a fluid level, the fluid level sensing system comprising a conductivity sensor for determining a conductivity of the fluid to be measured and an inductor configured to be oriented perpendicular to a fluid surface An inductance measuring system, such as for example an inductance to digital convertor (LDC) with digital proximity output, can be connected to the inductor. In one embodiment, the conductivity sensor can also be an inductor, and inductances can be measured using a common inductance measuring system.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 displays a classic sounding pole as known from prior art.

FIG. 2 an example of a small waterway profile as can be evaluated using an embodiment of the present invention.

FIG. 3 displays an array of sensors integrated along the sounding pole, illustrating a system according to an embodiment of the present invention.

FIG. 4 displays an exemplary tip of the sounding pole, according to an embodiment of the present invention.

FIG. 5 displays the force balance on the sounding pole when intruding the sediment, as can be obtained using an embodiment of the present invention.

FIG. 6 displays an exemplary automated sounding pole according to an embodiment of the present invention.

FIG. 7 displays a handheld density profiler according to an embodiment of the present invention.

FIG. 8 to FIG. 11 display different schematic representations of systems according to an embodiment of the present invention.

FIG. 12 displays a vertical X-ray density scan of a sediment sample as can be obtained using an embodiment of the present invention.

FIG. 13 displays a density interpretation based on FIG. 5.

FIG. 14 displays a yield strength map as can be obtained using embodiments according to the present invention.

FIGS. 15 and 16 displays the analysis of a horizontal slice through a CT-scanned sediment volume as can be used according to embodiments of the present invention.

FIG. 17 shows a schematic representation of a sounding pole according to an embodiment of the present invention, comprising a magnetic field sensor.

FIG. 18 illustrates a fluid level sensor based on inductors, according to an embodiment of the present invention.

FIG. 19 illustrates a profiling system according to an embodiment of the present invention.

The drawings are only schematic and are non-limiting. In the drawings, the size of some of the elements may be exaggerated and not drawn on scale for illustrative purposes.

Any reference signs in the claims shall not be construed as limiting the scope.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the present invention relates to a profiling system for obtaining information regarding a mud, sediment, sand or soil, the profiling system comprising a sounding pole, a sensor array provided along the sounding pole, the sensor array being configured for providing a different output signal in air, water and sediment. In some embodiments, e.g. wherein the profiling system is a static system mounted at a place of interest, the above system can be used for obtaining accurate information regarding a mud, a sediment, sand or soil or a profile thereof. In some other embodiments, the system also may optionally comprise a measurement unit for determining a resistance on the sounding pole, e.g. in case of a handheld device when it is intruding the sediment. According to embodiments of the present invention a processing unit programmed for determining, based on an output of the sensor array and optionally on an output of the measurement unit, information of the mud, sediment, sand or soil. In case of a handheld device, the latter could be obtained substantially independent of operator characteristics of the way of introducing the handheld profiling sounding pole also is provided. It is an advantage of embodiments of the present invention that they can provide information regarding the mud, sediment, sand or soil without the effects stemming from an irregular movement of the handheld probing system influencing the result.

By way of illustration, some standard and optional features will be illustrated using exemplary embodiments as shown in the drawings, embodiments not being limited thereto.

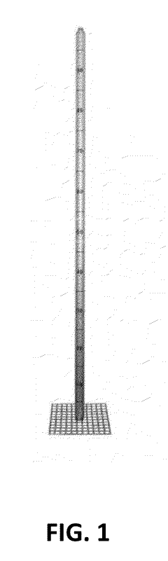

FIG. 1 displays a classic sounding pole that is used to measure the depth of an underwater sediment layer and the thickness of underwater sediment layer, as known from prior art.

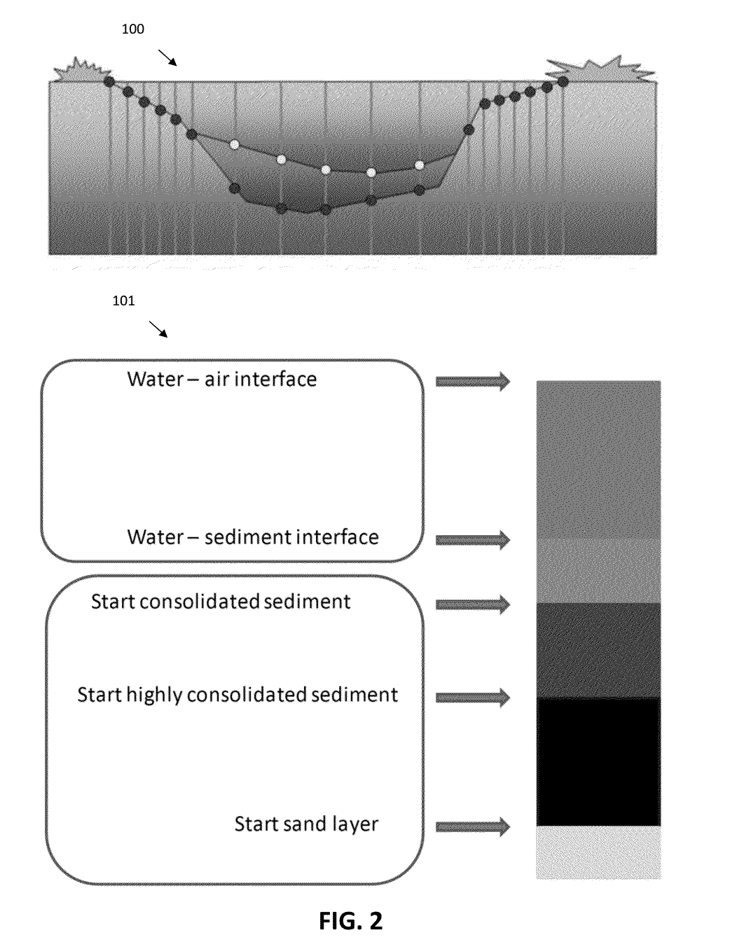

FIG. 2 an example of a small waterway profile. Several samples are taken with the sounding pole in a cross section of the water way. The measurement of the thickness of the sediment layer is used to calculate the volume to be dredged. Different parameters are important as the top water level, top sediment level and top of the hard soil level.

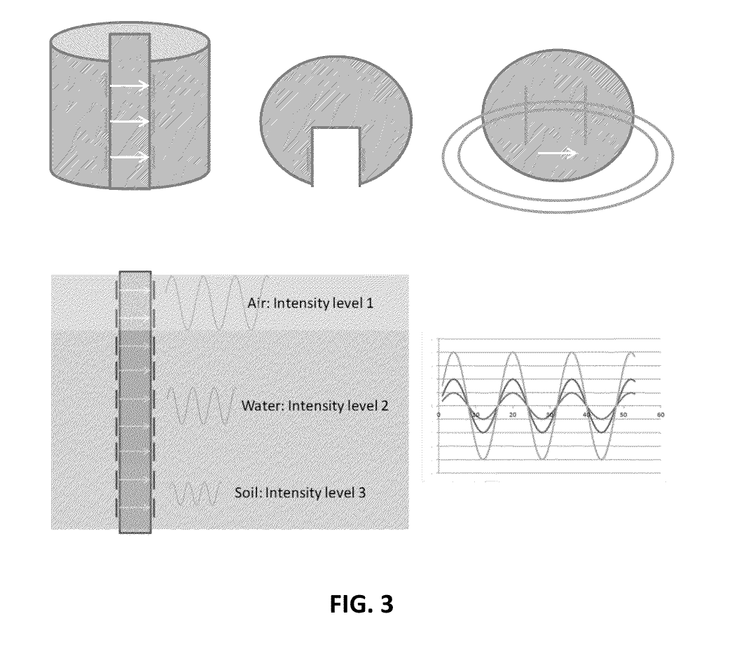

FIG. 3 displays an array of sensors integrated along the rod, illustrating a system according to an embodiment of the present invention. The sensors are e.g. capacitive sensors where the material between the capacitor plates determines the capacity level. By measuring the capacitor by applying an AC signal different material between the capacitor plates can be distinguished. The interface between air and water can be detected. The water height can be detected. The interface between water and top of the sediment can be determined. The sediment height can be determined.

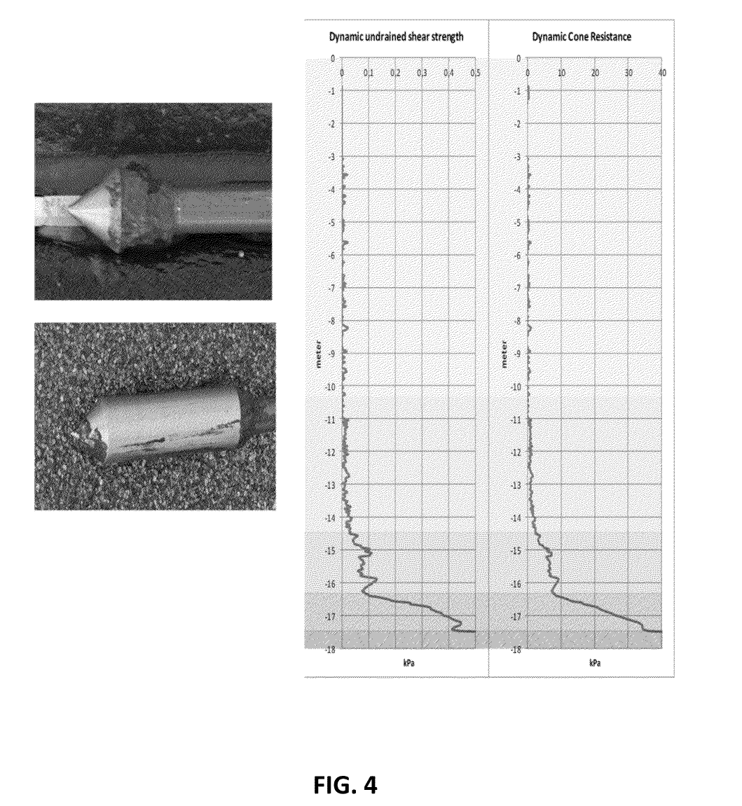

FIG. 4 displays the tip of the sounding pole. The tip can be installed with a conus to measure the conus resistance during intrusion and a sleeve to measure the sleeve resistance during intrusion.

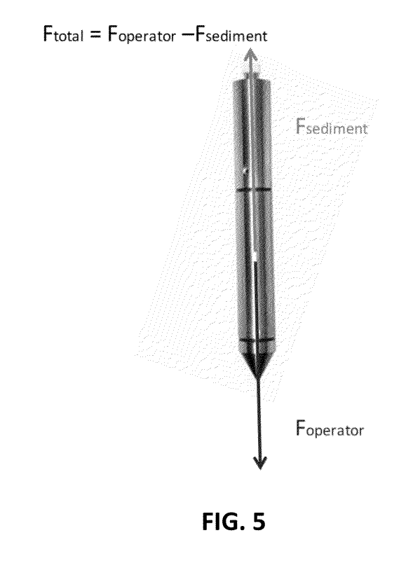

FIG. 5 displays the force balance on the rod when intruding the sediment. When the total force is measured by the on board accelerometer and the resistance force of the sediment is measured by the conus, the applied force of the operator can be determined. By knowing the applied force of the operator a calibration can be installed and a resistance criterion independent from the operator can be determined.

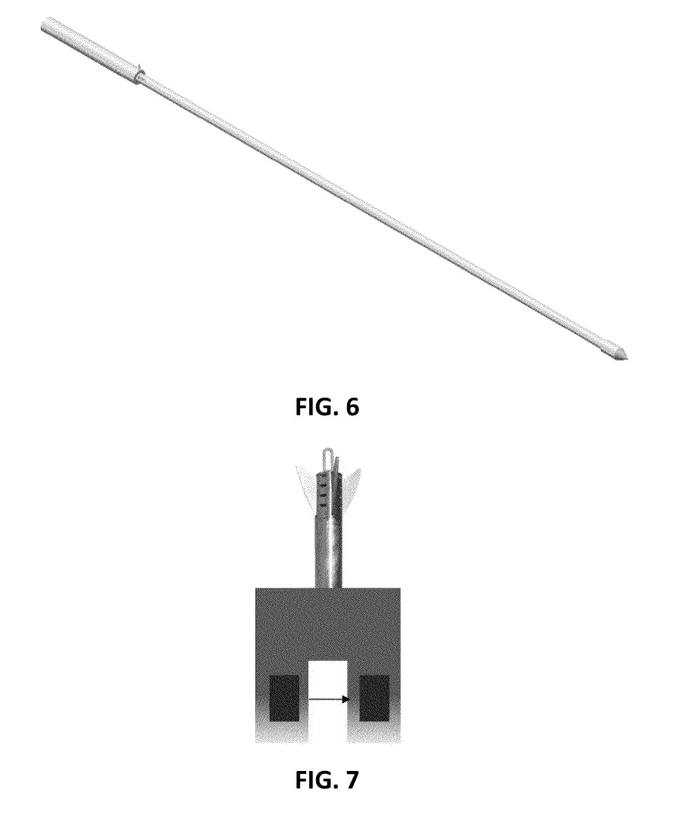

FIG. 6 displays a total integrated rod with a cone on the tip and a bottle on the tail. In the bottle all processing electronics is located containing data acquisition electronics, battery, microprocessors and embedded software.

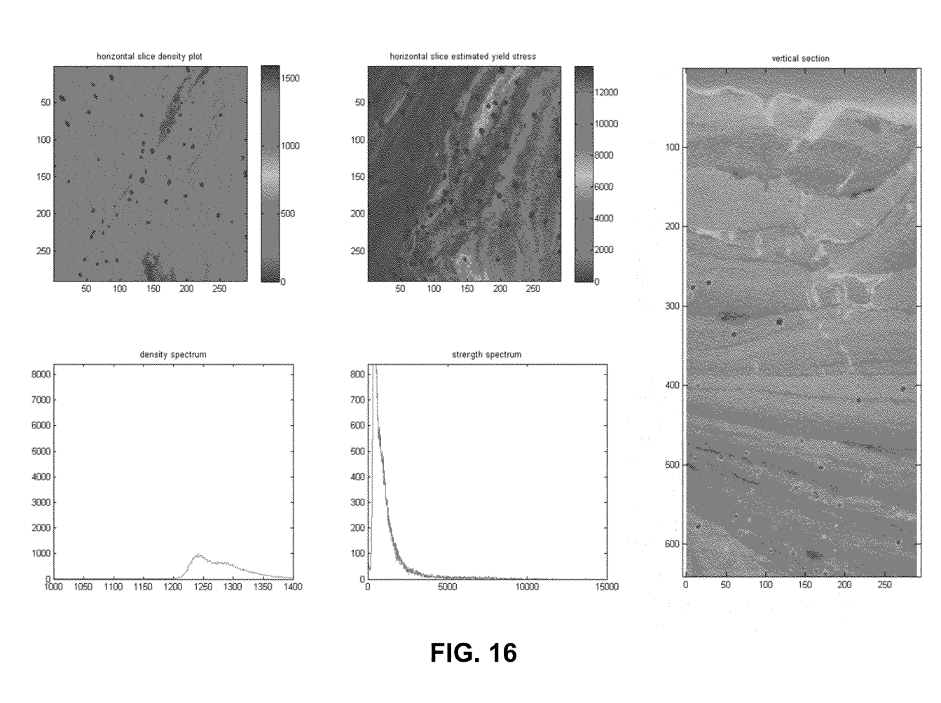

In one embodiment according to the present invention, the measurement unit may comprise a magnetic force based sensor. Such a sensor may for example have two or more magnets and be based on sensing magnet field changes caused by relative movement of the magnets with respect to each other. The force between two magnetic poles of magnets is complex but can be described in a simplified manner as F=(μ.q1.q2)/(4.π.r2) where F is the force, q1 and q2 is the magnitudes of the magnetic poles, μ is the permeability of the medium and r is the distance between the two magnets. When a force is applied on the sounding pole, the distance between the two or more magnets changes, and a change in the field in the neighbourhood of the magnets can be detected. Measurement of these magnet field changes allows to derive the force that is applied on the sounding pole. It is an advantage of magnet based sensing that the non-linear displacement-force relation allows to span a wide span of force measurements. One example of a technique for measuring magnet changes is based on an inductance. An inductance is mounted in the magnetic field of the two or more magnets, e.g. in between or close to the magnets. The inductor may be arranged along the length of the sounding pole. An inductive to digital convertor is connected to the inductance mounted in the field of the two magnets and is used to measure the changes in the magnetic field generated by modifying the distance between the two magnetic poles. In one particular example, de inductor may be a solenoid being 5 cm long, 125 windings, a field of 730 pH, a resonance frequency of 350 kHz, an ohmic resistance of 1.3 ohm. The magnets used are ring magnets having a diameter of 25 mm, a central hole with diameter 10 mm and a height of 10 mm. As indicated, due to the non-linearity of the force equation the device is capable of measuring a wide range of forces with a varying accuracy. Since high accuracy at low forces and low accuracy at high forces is required, sensing based on magnetic interaction is capable of delivering the position of the top of a quasi-fluid mud layer and a hard resistive layer, as indicated in FIG. 17. In FIG. 17 an inductance measurement system 1703 and a first magnet 1701 and second magnet 1702 are shown. Whereas in the present example magnetic field measurements are based on an inductance measurement, using an inductor, alternative magnetic field measurement systems may be applied, such as GMR, TMR, AMR based sensors, hall-measurement based sensors, etc. In the exemplary configuration, one magnet is fixed and the other magnet is mounted on a stick held by bearings such that the stick slides smoothly in the bearing, allowing the measurement of low resistances when the spacing of the magnets is at a maximum. In embodiment of the present invention, one magnet may be fixed and one magnet may be configured slideable with respect to the fixed magnet.

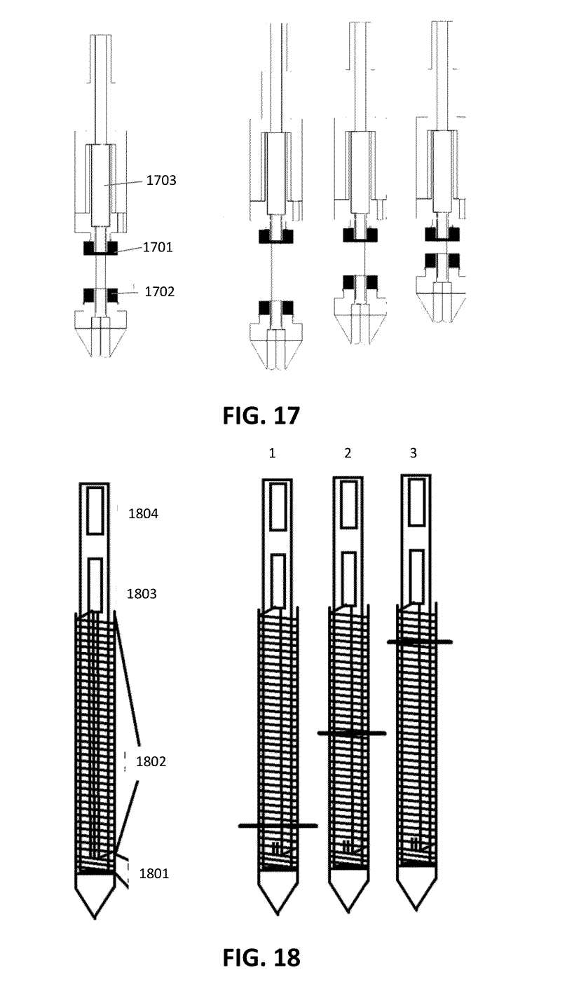

In one embodiment, the probing system may be adapted for performing water level based sensing. The water level sensing may be based on the use of inductors with a certain length mounted on a rod in a water proof housing and brought in resonance. The smallest inductor (corresponding with the smallest resonance) on the tip of the sensor rod serves as conductivity sensor for determining conductivity of the fluid sensed, while the largest inductance serves as level sensor. In some examples, also an alternative measurement system for determining conductivity can be used so that only a single inductor is required. The probing system thus may be furthermore adapted with one or more inductors for determining a water level. An inductance to digital convertor (LDC) with digital proximity output is connected to the one or more inductances (FIG. 18). Measurement of the inductance or a change thereof can provide information regarding the fluid level, e.g. water level. In FIG. 18 at the left hand side, the operation principle is explained for the current embodiment, while in FIG. 18 at the right hand side the detection system is illustrated for three different water levels. In the example of FIG. 18, a reference conductivity sensor 1801, an inductive water level sensor 1802, an inductance to digital convertor 1803 and a data logger are shown. Due to the presence of water and the conductivity of the water near the inductive sensor, the proximity output of the LDC changes. For example, an inductance with a physical length of 50 cm as such has sub millimeter resolution and accuracy in water level sensing when the conductivity of the water is known. Several conductivity sensors can be integrated in the measurement rod. Inductive conductivity sensors mounted at known intervals can also be used as both level sensors and conductivity sensors. Whereas the above embodiment has been described as a handheld probing system with additional sensors for water level detection, a probing system, handheld or not handheld, that does not have the specific features of the first aspect, but has a conductivity sensor—e.g. an inductor but not limited thereto—and an inductor along a length of the probing system for detecting a water level also is envisaged. Such systems may for example be used not only for inspection of waterways or for detecting a water level in the ground, but also for detection of water levels in spaces or rooms, e.g. for alerting people, initiating pumps, etc. In other words, the present invention also relates to a fluid level sensing system for determining a fluid level, the fluid level sensing system comprising a conductivity sensor for determining a conductivity of the fluid to be measured and an inductor configured to be oriented perpendicular to a fluid surface, e.g. perpendicular to a water surface. An inductance measuring system, such as for example an inductance to digital convertor (LDC) with digital proximity output, can be connected to the inductor. Using the conductivity of the fluid, measured using a conductivity sensor, the level of the fluid can be determined, i.e. derived from the changed inductance. Such deriving can be based on calculations, a look up table, a neural network, an algorithm, etc.

In some embodiments of the present invention, the profiling system thus is not a handheld profiling system, but a profiling system that is fixedly positioned at a position of interest, e.g. to see the evolution of a sediment layer. The system may then only comprise the sensor array, and e.g. not a further measurement unit.

In another aspect, the present invention relates to a processing unit for use with a handheld profiling system, e.g. a handheld profiling system as described above, the processing unit being adapted for determining, based on an output of a sensor array on a sounding pole of the handheld profiling system and on an output of a measurement unit on the sounding pole of the handheld profiling system, information of the mud, sediment, sand or soil.

In yet another aspect, the present invention relates to a computer program product for determining information of a mud, sediment, sand and/or soil, the computer program product being adapted for, when run on a computer, providing the functionality of the processing means described in the above aspect. Such a computer program product may be a web application. A data carrier comprising such a computer program product and transmission of such a computer program product also is envisaged.

In another aspect, the present invention relates to a method for determining information regarding a mud, sediment, sand or soil, the method comprising, introducing a handheld profiling sounding pole into a waterway until a hard layer is reached, obtaining, during said introducing, information of a sensor array configured for providing a different output signal in air, water and sediment, and information of a measurement unit for determining a resistance on the sounding pole, and determining based on the obtained information, information of the mud, sediment, sand or soil substantially independent of operator characteristics of the way of introducing the handheld profiling sounding pole. The method may include further steps expressing the functionality of the device features as disclosed with the profiling system as described above.

In one aspect, the present invention relates to a probing or profiling system for obtaining information regarding a mud, sediment, sand or soil. The probing or profiling system may be a handheld system, although embodiments of the present invention are not limited thereto. The system may be a sounding pole but alternatively also may be a penetrometer, such as for example a free fall penetrometer. It also may be another probing or profiling system. According to embodiments of the present invention, the probing or profiling system comprises two or more magnets and a magnetic field sensor for sensing a change in a relative distance between the two or more magnets induced by a resistance or force on the probing system. The magnets may be permanent magnets but are not limited thereto. By way of illustration, further standard and optional features will now be described in more detail. The magnetic force based sensor may be introduced at a top of the probing or profiling system, e.g. at a conically shaped portion of the probing or profiling system that typically is used to first enter the water, ground, mud, sediment, sand or soil when probing. Such a sensor may for example have two or more magnets and be based on sensing magnet field changes caused by relative movement of the magnets with respect to each other. The force between two magnetic poles of magnets is complex but, by way of illustration, can be described in a simplified manner as F=(μ.q1.q2)/(4.π.r2) where F is the force, q1 and q2 is the magnitudes of the magnetic poles, μ is the permeability of the medium and r is the distance between the two magnets. When a force is applied on the sounding pole, the distance between the two or more magnets changes, and a change in the field in the neighbourhood of the magnets can be detected. Measurement of these magnet field changes allows to derive the force that is applied on the sounding pole or a parameter related thereto. The above identified simplified relation can be used but alternatively also more complex description of the interaction between the magnets can be used for deriving the force or a parameter related thereto. Alternatively, use can also be made of a look up table, e.g. based on a calibration, a neural network, an algorithm, etc. It is an advantage of magnet based sensing that the non-linear displacement-force relation allows to span a wide span of force measurements. One example of a technique for measuring magnet changes is based on an inductance. An inductance is then mounted in the magnetic field of the two or more magnets, e.g. in between or close to the magnets. An inductive to digital convertor is connected to the inductance mounted in the field of the two magnets and is used to measure the changes in the magnetic field generated by modifying the distance between the two magnetic poles. Alternative magnetic field measurement systems that may be applied are for example GMR, TMR, AMR based sensors, hall-measurement based sensors, etc. As indicated, due to the non-linearity of the force equation the device is capable of measuring a wide range of forces with a varying accuracy. Since high accuracy at low forces and low accuracy at high forces is required, sensing based on magnetic interaction is capable of delivering the position of the top of a quasi-fluid mud layer and a hard resistive layer.

The present invention furthermore relates to a processing means or processor for deriving information of the mud, sediment, sand or soil based on magnetic field measurements obtained from a magnetic sensor in a system as described above. Such a processing means or processor may also be integrated in the probing or profiling system.

In one aspect, the present invention relates to a handheld profiling system for obtaining information regarding a mud, sediment, sand or soil. The handheld profiling system comprises a sounding pole and a magnetic sensor unit comprising a floating member slideably mounted on the sounding pole, a magnetic element comprised in the floating member and a magnetic sensor array provided along the sounding pole, the sensor array being configured for identifying a position of the magnetic element along the sounding pole. According to embodiments of the present invention also comprises a measurement unit for determining at least one of a point resistance, a water pressure or a shear resistance on the sounding pole. In some embodiments of the present invention, the profiling system also comprises a processing unit programmed for determining, based on an output of the magnetic sensor unit and on an output of the measurement unit information of the mud, sediment, sand or soil substantially independent of operator characteristics of the way of introducing the handheld profiling sounding pole.

The magnetic sensor array may comprise GMR, TMR, AMR based sensors, hall-measurement based sensors, etc. the magnetic element may be ring shaped although embodiments are not limited thereto.

The measurement unit may comprise in one embodiment a cone shaped tip, whereby a point resistance, a water pressure or a shear resistance can be measured. In a particular embodiment, the measurement may be based on a strain gauge. Other systems as can be used for point resistance measurements, water pressure measurements or shear resistance measurements can also be implemented. Known measurement systems allowing to measure these parameters can also be used.

It is to be noticed that other features as described in the first and further aspects, can be applied mutates mutandis to the present aspect. Examples thereof may be the presence of an accelerometer, a chemical sensor, a GPS, etc.

In one embodiment, the processing unit may be adapted for deriving a speed of the intrusion of the sounding pole and for using said speed for scaling obtained resistance measurements. Based on the determined speed, the dynamical resistance measurements can be converted into static resistance values.

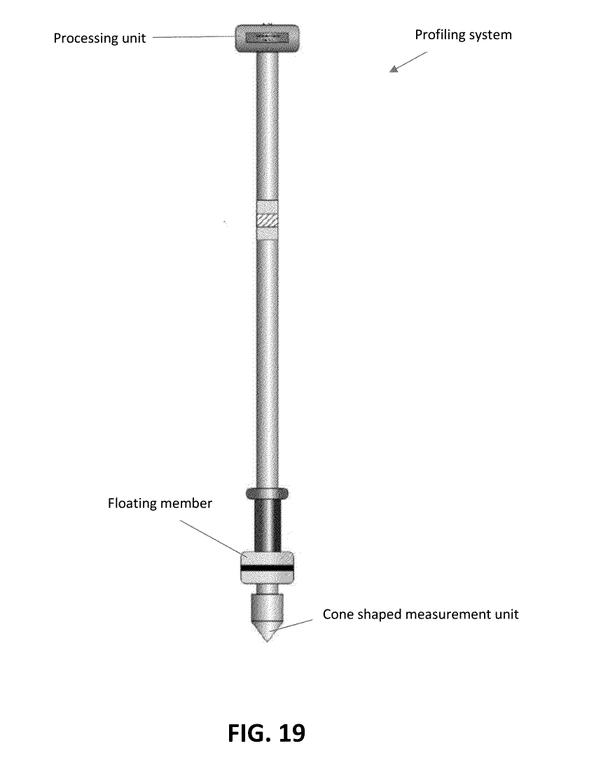

By way of illustration, embodiments of the present invention not being limited thereto, an example of such a system is shown in FIG. 19.

In one aspect, the present invention also relates to a corresponding processing unit for use with a handheld profiling system. Such a processing unit may be similar as described in other aspects, but is in the present embodiment characterized by being programmed for determining, based on an output of a magnetic sensor unit comprising a floating member slideably mounted on a sounding pole, a magnetic element comprised in the floating member and a magnetic sensor array provided along the sounding pole, the magnetic sensor array being configured for identifying a position of the magnetic element along the sounding pole and a measurement unit for determining at least one of a point resistance, a water pressure or a shear resistance on the sounding pole, information of the mud, sediment, sand or soil substantially independent of operator characteristics of the way of introducing the handheld profiling sounding pole.

In yet another aspect, the present invention also relates to a method for determining information regarding a mud, sediment, sand or soil. The method comprises introducing a handheld profiling sounding pole into a waterway until a hard layer is reached, obtaining, during said introducing, information of a magnetic sensor unit comprising a floating member slideably mounted on the sounding pole, a magnetic element comprised in the floating member and a magnetic sensor array provided along the sounding pole, the sensor array being configured for identifying a position of the magnetic element along the sounding pole, and information of a measurement unit for determining at least one of a point resistance, a water pressure or a shear resistance on the sounding pole, and determining based on the obtained information, information of the mud, sediment, sand or soil substantially independent of operator characteristics of the way of introducing the handheld profiling sounding pole.

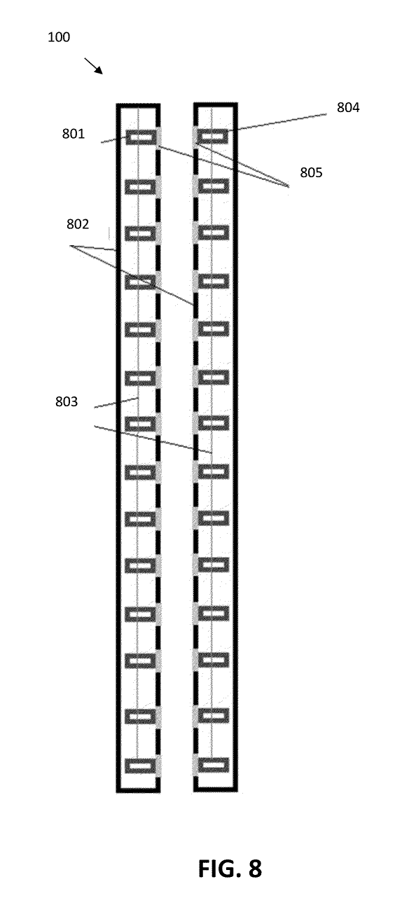

In one aspect, the present invention relates to a profiling system for obtaining information regarding a mud, sediment, sand or soil, the profiling system being a handheld profiling system comprising an X-ray source and a semiconductor based photodetector, the x-ray source and the semiconductor based photodetector being configured for performing X-ray measurements of the mud, sediment, sand or soil for determining a density based on said profiling. A system according to an exemplary embodiment of the present invention is shown in FIG. 7 displaying a handheld density profiler less than 10 kg based on an X-ray source and a silicon photon detector. Standard and optional features of the system described in the following aspect may, mutates mutandis, also be applied.

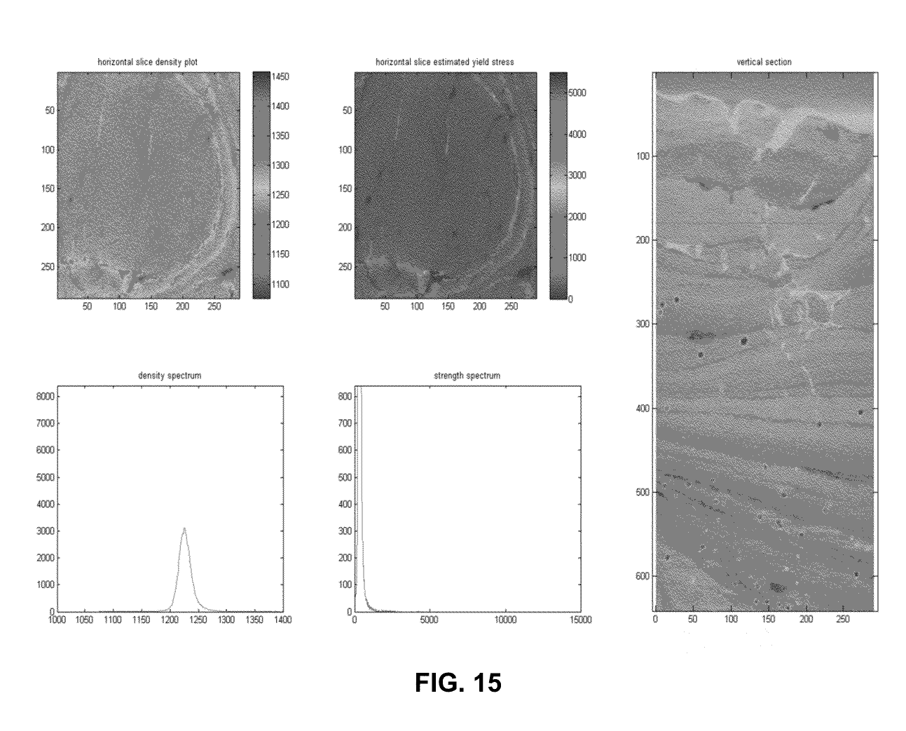

FIG. 15 displays the analysis of a horizontal slice through a CT-scanned sediment volume. The derived density spectrum is narrow and the resulting strength spectrum is narrow as well, making the mean density value a good strength predictor.

FIG. 16 displays the analysis of a horizontal slice through a CT-scanned sediment volume. The derived density spectrum is wide and the resulting strength spectrum is wide as well. The mean density in this case is not a good predictor for sediment strength. Measuring the density spectrum allows to have a strength estimate.

In one aspect, the present invention relates to a profiling system for obtaining information regarding a mud, sediment, sand or soil, the system comprising a first elongated element comprising an x-ray radiation source system for emitting x-rays and a second elongated element comprising an x-ray detector system for detecting x-rays, X-rays may for example refer to electromagnetic radiation with an energy in the range 1 keV to 200 keV, e.g. in the range 10 keV to 200 keV, e.g. in the range 15 keV to 150 keV, e.g. in the range 30 keV to 150 keV. The first elongated element and the second elongated element may be transparent for x-rays along at least a part of their length. According to embodiments, the x-ray radiation source system and the x-ray detector system being configured in the first elongated element respectively second elongated element so that at a plurality of positions along the length of the first and the second elongated elements x-ray radiation emitted from the x-ray radiation source system can be detected by the x-ray detector system. The materials used may be any suitable material, such as but not limited to composite material.

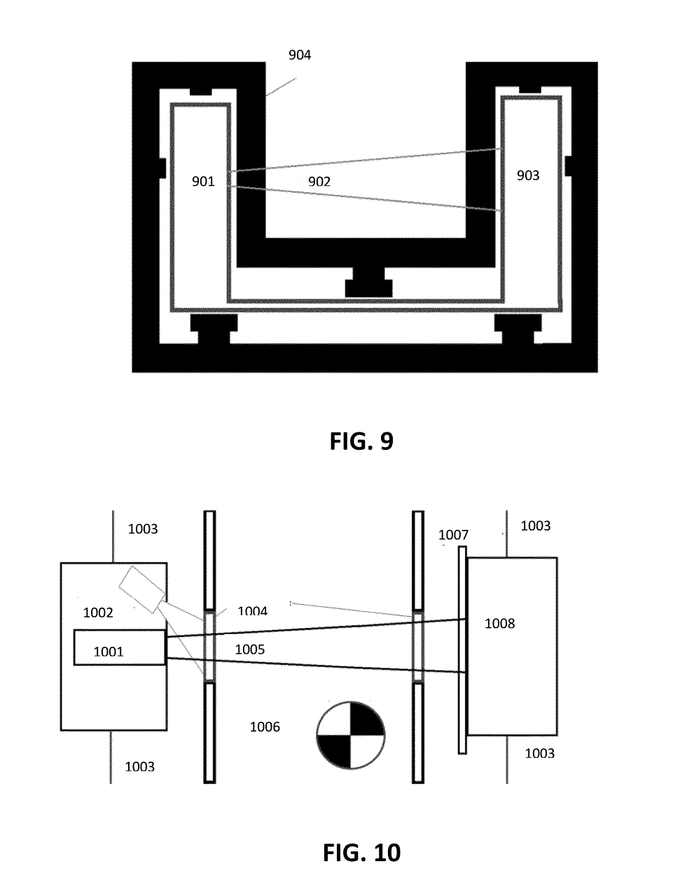

By way of illustration, embodiments of the present invention not being limited thereto, example of optional features have been described above and will be described below, with reference to the drawings. FIG. 8 displays a set of X-ray sources and receivers positioned in an array, as can be used in embodiment according to the present invention. The proposed set-up allows the measurement of a vertical density profile of the sediment at a predefined discrete distance interval. The X-ray sources and receivers are mounted in a metal housing with X-ray transparent windows. FIG. 8 shows x-ray transmission hardware 801, a waterproof housing 802, power and data lines 803, receiver hardware 804 and X-ray transparent windows 805.

FIG. 9 displays an extruded composite or other X-ray transparent material in which all rail and positioning infrastructure is available for the movement of an X-ray source and receiver configuration mounted on a sled. It is an advantage of the proposed set-up that source and receiver do not move independently. It is an advantage of the extrusion of the tube that all necessary infrastructure to guide and position the X-ray source and receiver configuration is entirely available and factory calibrated. In FIG. 9 an X-ray source 901, an X-ray beam 902, an X-ray receiver 903 and an X-ray transparent extruded composite material housing 904 is shown.

FIG. 10 displays a source and receiver configuration mounted in a tube equipped with X-ray transparent windows. In such a configuration, positioning of the configuration must be exact. Optical markers or any other type of markers can be used to position both source and receiver unit, allowing independent movement in two separate tubes. FIG. 10 illustrates an X-ray generator 1001, a camera or other position detector 1002, a laser distance measurement 1003, an x-ray transparent window 1004, an x-ray beam 1005, an X-ray window containing inside an optical positioning disk such as a secchi disk or reflectors 1006, a discrete element x-ray receiver 1007, and X-ray receiver electronics.

FIG. 11 displays metal clamps to guide X-ray transparent tubes in which source and receiver unit move independent. A vertical discrete receiver array allows an automatic positioning of the X-ray receiver. In FIG. 11, an X-ray source 1101, an X-ray receiver 1102, the X-ray beam 1103 and an X-ray transparent liner 1104 and an X-ray transparent metal liner clamp 1105 is indicated. If the X-ray receiver comprises discrete elements, i.e. if the receiver is an array, this may allow auto search of the X-ray beam.

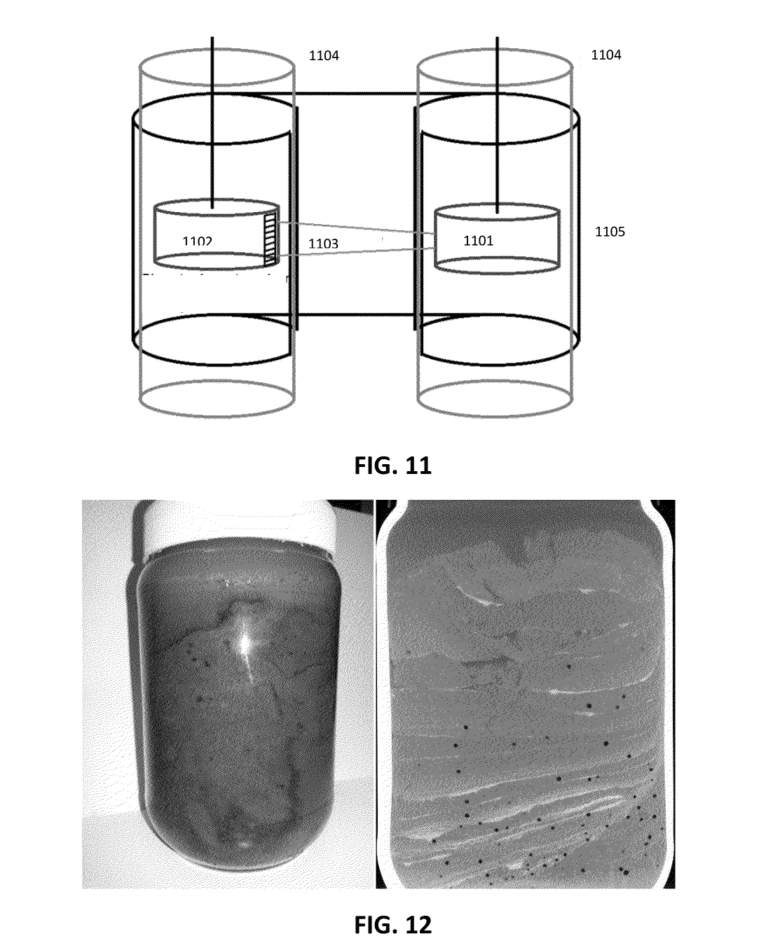

FIG. 12 displays a vertical X-ray density scan of a sediment sample, where black is air and white is the highest density.

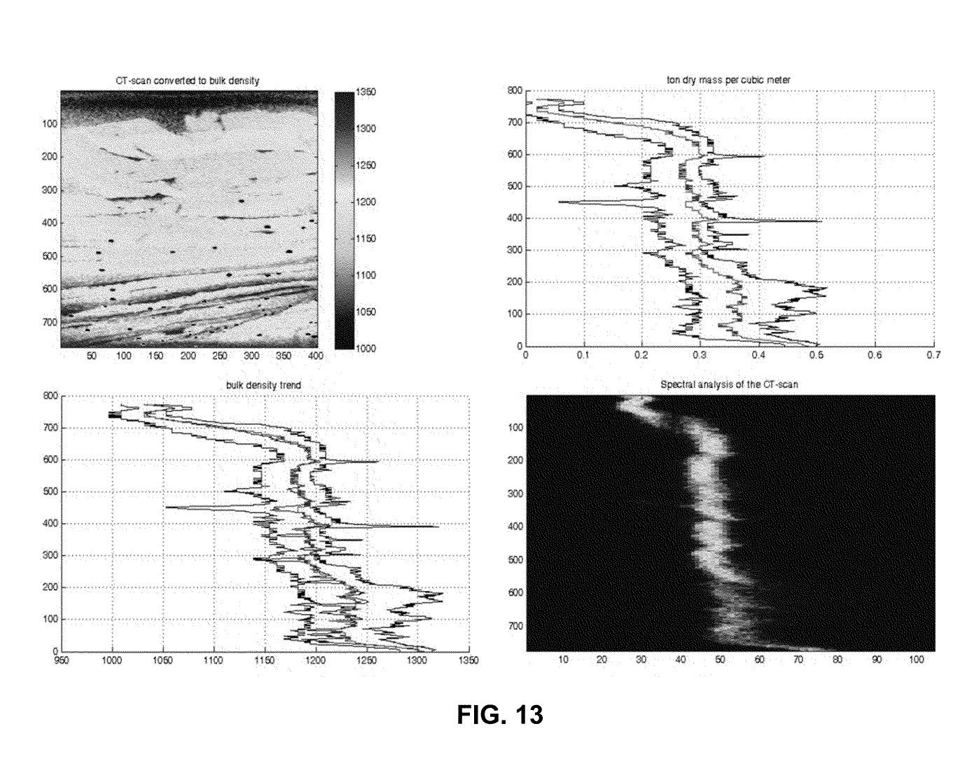

FIG. 13 displays a density interpretation of FIG. 12 and a vertical bulk density profile and related ton dry mass profile

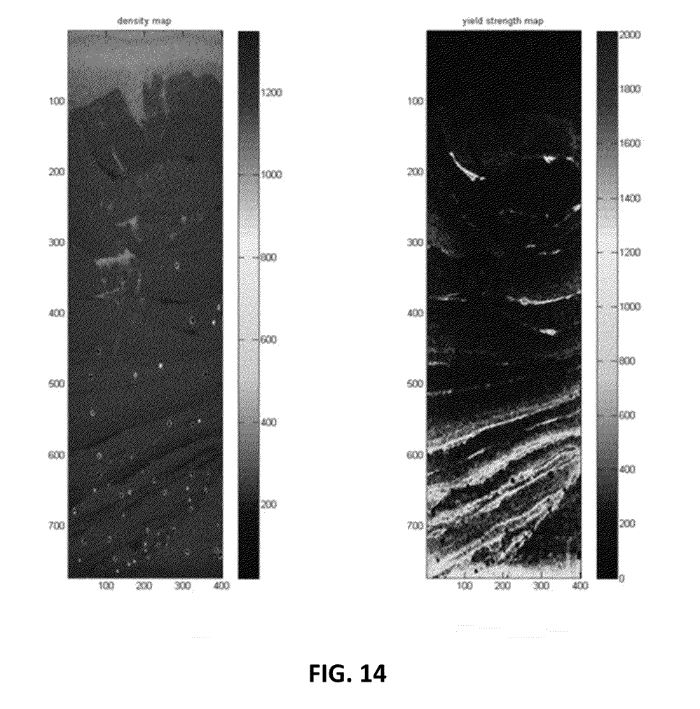

FIG. 14 displays a yield strength map derived from the bulk density map based on equilibrium flow conditions and thyxotropic properties.

In another aspect, the present invention relates to a processing means for determining mud, sediment, sand or soil characteristics. The processing means being adapted for receiving X-ray data recorded of a mud, sediment, sand or soil. The processing means may therefore comprise an input port, or may be coupled or be part of a profiling system as described in the first aspect. The processing means furthermore is programmed for deriving, based on the X-ray data, at least the density of the mud, sediment, sand or soil.

In yet another aspect, the present invention relates to a dredging hopper, wherein the dredging hopper comprises a profiling system as described in the first aspect.

In still another aspect, the present invention relates to the use of a system as described in the first aspect or to the use of a processing means as described in the second aspect for determining a characteristic of a mud, sediment, sand or soil. The use may be for determining a dynamic characteristic, such as for example a mass transport, or may be for determining a static characteristic, such as for determining a density.

1. A handheld profiling system for obtaining information regarding a mud, sediment, sand or soil, the handheld profiling system comprising
a sounding pole
a magnetic sensor unit comprising a floating member slideably mounted on the sounding pole, a magnetic element comprised in the floating member and a magnetic sensor array provided along the sounding pole, the sensor array being configured for identifying a position of the magnetic element along the sounding pole,
a measurement unit for determining at least one of a point resistance, a water pressure or a shear resistance on the sounding pole, and
a processing unit programmed for determining, based on an output of the magnetic sensor unit and on an output of the measurement unit information of the mud, sediment, sand or soil substantially independent of operator characteristics of the way of introducing the handheld profiling sounding pole.

2. A handheld profiling system according to claim 1, wherein the magnetic sensor array is integrated in the sounding pole.

3. A handheld profiling system according to claim 1, wherein the magnetic sensor array is an array of hall sensor elements.

4. A handheld profiling system according to claim 1, wherein the processing unit is programmed for determining the applied force of the operator on the sounding pole using a force balance based on the overall force and a resistance measurement or wherein the processing unit is programmed for determining the applied energy of the operator on the sounding pole using an energy balance based on the kinetic energy and energy losses on the sounding pole.

5. A handheld profiling system according to claim 1, wherein the processing unit is programmed for determining based on the magnetic sensor unit and the measurement unit information on the interface of air and water and/or of water and sediment and/or wherein the processing means is programmed for determining a speed of the rod based on a sensor output of sensors in the magnetic sensor array during said profiling and/or wherein the processing unit is programmed for determining a hard bottom of a waterway based on an output of the measurement unit.

6. A handheld profiling system according to claim 1, wherein the measurement unit is a cone resistance measurement unit.

7. A handheld profiling system according to claim 1, wherein the measurement unit is configured for determining a shear strength or a cone penetration resistance and/or wherein the sounding pole has a conically shaped top.

8. A handheld profiling system according to claim 6, wherein the measurement unit comprises an electric strain gauge for determining any of a point resistance, a water pressure or a shear resistance.

9. sounding pole A handheld profiling system according to claim 8, wherein the system furthermore comprises a membrane for shielding the strain gauge from water.

10. A handheld profiling system according to claim 1, the system furthermore comprising a chemical sensor for measuring contamination.

11. A handheld profiling system according to claim 1, wherein the system comprises any or a combination of an accelerometer whereby the processing unit is further programmed for determining an overall force on the rod based on accelerometer data, an inclinometer configured for providing information regarding an overall inclination of the rod, a GPS configured for providing information regarding an overall position of the rod, a conductivity sensor and an inductor oriented along the length of the profiling system configured for determining a fluid level based on an inductance measured in the inductor.

12. A handheld profiling system according to claim 1, wherein the magnet is any of a permanent magnet or an electromagnet.

13. A handheld profiling system according to claim 1, wherein the processing unit is adapted for determining a speed of intrusion of the sounding pole and for using said determined speed for determining a static value of a resistance measurement.

14. A processing unit for use with a handheld profiling system, the processing unit being programmed for determining, based on an output of a magnetic sensor unit comprising a floating member slideably mounted on a sounding pole, a magnetic element comprised in the floating member and a magnetic sensor array provided along the sounding pole, the magnetic sensor array being configured for identifying a position of the magnetic element along the sounding pole and a measurement unit for determining at least one of a point resistance, a water pressure or a shear resistance on the sounding pole, information of the mud, sediment, sand or soil substantially independent of operator characteristics of the way of introducing the handheld profiling sounding pole.

15. A processing unit according to claim 14, wherein the processing unit is programmed for determining based on the magnetic sensor unit and the measurement unit information the interface of air and water.

16. A processing unit according to claim 14, wherein the processing unit is programmed for determining a speed of the sounding pole based on the magnetic sensor unit during said profiling.

17. A processing unit according to claim 14, wherein the processing unit is programmed for determining a hard bottom of a waterway based on an output of the measurement unit.

18. A processing unit according to claim 14, wherein the processing unit is programmed for determining the applied force of the operator on the sounding pole using a force balance based on the overall force and a resistance measurement.

19. A processing unit according to claim 14, wherein the processing unit is programmed for determining the applied energy of the operator on the sounding pole using an energy balance based on the kinetic energy and energy losses on the sounding pole.

20. A method for determining information regarding a mud, sediment, sand or soil, the method comprising,
introducing a handheld profiling sounding pole into a waterway until a hard layer is reached,
obtaining, during said introducing, information of a magnetic sensor unit comprising a floating member slideably mounted on the sounding pole, a magnetic element comprised in the floating member and a magnetic sensor array provided along the sounding pole, the sensor array being configured for identifying a position of the magnetic element along the sounding pole, and information of a measurement unit for determining at least one of a point resistance, a water pressure or a shear resistance on the sounding pole, and
determining based on the obtained information, information of the mud, sediment, sand or soil substantially independent of operator characteristics of the way of introducing the handheld profiling sounding pole.
